(19) United States
(12) Patent Application Publication
(10) Pub. No.: US 2007/0124798 A1
(43) Pub. Date: May 31, 2007

(54) Tying hard drives to a particular system

(75) Inventor: Lowell B. Dennis, Pflugerville, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/288,563

(22) Filed: Nov. 29, 2005

(51) Int. Cl. H04L 9/32; G06K 9/00

(52) U.S. Cl. 726/2

(57) ABSTRACT

In a system for accessing data stored on a storage device (SD) that is capable of being coupled to an information handling system (IHS), the SD includes a lock to control access to the data by a program and includes a storage media to store the data. The program is configured to execute on the IHS. The lock includes a first identifier to authenticate the program and a second identifier to authenticate the IHS. The lock permits access to the data when both the program and the IHS are authenticated, whereas the lock denies access to the data when the SD is coupled to another IHS.

### BACKGROUND

The present disclosure relates generally to data storage devices, and more particularly to tools and techniques for enhancing security of data stored on storage devices included in an information handling system.

As the value and use of information continues to increase, individuals and businesses seek additional ways to acquire, process and store information. One option available to users is information handling systems. An information handling system (‘IHS’) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, entertainment, and/or global communications. In addition, information handling systems may include a variety of hardware and software components that may be configured to process, store, and communicate information and may include one or more computer systems, data storage systems, and networking systems.

Depending on capacity and performance requirements, storage devices included in an IHS may be available in various forms based on use of magnetic and/or optical read/write technology. For example, use of a hard disk drive (HDD) having a fixed and/or removable magnetic media is well known.

Use of secure methods for identifying and/or authenticating a user is essential to the trustworthiness of many IHS applications. Presently, data stored on the HDD may be secured by passwords. That is, the use of passwords may limit the HDD access to those who know the password. The integrity of the HDD coupled to a secure IHS system may, however, be compromised by physically removing the HDD from the secure IHS system, plugging the HDD into an unsecured system and accessing secured data by use of an authorized and/or reverse engineered password.

Therefore, a need exists to provide for enhanced security of storage devices. Accordingly, it would be desirable to provide an improved method and system for securing access to a storage device that is included in an information handling system, absent the disadvantages found in the prior methods discussed above.

### SUMMARY

The foregoing need is addressed by the teachings of the present disclosure, which relates to providing secured access to data stored on storage devices. According to one embodiment for accessing data stored on a storage device (SD) that is capable of being coupled to an information handling system (IHS), the SD includes a lock to control access to the data by a program and includes a storage media to store the data. The program is configured to execute on the IHS. The lock includes a first identifier to authenticate the program and a second identifier to authenticate the IHS. The lock permits access to the data when both the program and the IHS are authenticated, whereas the lock denies access to the data when the SD is coupled to another IHS.

### BRIEF DESCRIPTION OF THE DRAWINGS

FIG. 1 illustrates a block diagram of an information handling system 100 having an improved storage device, according to an embodiment;

FIG. 2A is a block diagram illustrating further details of an improved storage device (SD) described with reference to FIG. 1, according to an embodiment;

FIG. 2B is a block diagram illustrating further details of an improved storage device (SD) described with reference to FIG. 1, according to an embodiment;

FIG. 3A is a flow chart illustrating a method for configuring a lock described with reference to FIG. 2A and FIG. 2B, according to an embodiment;

FIG. 3B is a flow chart illustrating a method for securely accessing a storage device, according to an embodiment;

FIG. 3C is a flow chart illustrating a method for securely accessing a storage device using a combined identifier, according to an embodiment; and

FIG. 3D is a flow chart illustrating a method for changing authentication parameters, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements.

Data may be stored on a storage device (SD) included in an information handling system (IHS). Access to the data may be secured by a variety of well known techniques such as passwords and use of cryptography. For these storage devices, it is desirable that the SD to be disabled when coupled to another unsecured IHS. That is, it is desirable that the data stored on the SD be accessed by a user and/or a program only from a particular IHS system, which may be configured for enhanced security. Examples of IHS systems configured for stringent security may include nuclear, defense, banking, intelligence, biotechnology and similar other applications. Presently, no tools and/or techniques exist to ensure that SD are accessible only when coupled to a particular, secured IHS system. Thus, a need exists to provide an improved method and system for enhanced security of storage devices.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IHS may be a personal computer, including notebook computers, personal digital assistants, cellular phones, gaming consoles, a network storage device, or any other suitable device and may vary in size, shape, performance, functionality, and price. The information handling system may include random access memory (RAM), one or more processing resources such as central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to receive/transmit communications between the various hardware components.

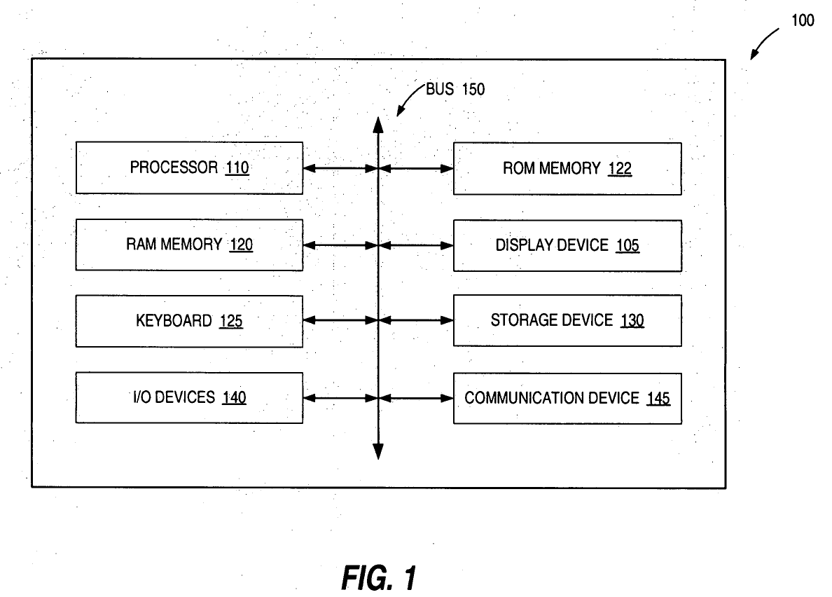

FIG. 1 illustrates a block diagram of an information handling system 100 having an improved storage device, according to an embodiment. The information handling system 100 having the improved storage device includes a processor 110, a system random access memory (RAM) 120 (also referred to as main memory), a non-volatile ROM 122 memory, a display device 105, a keyboard 125 and an I/O controller 140 for controlling various other input/output devices. For example, the I/O controller 140 may include a keyboard controller, a cursor device controller and/or the serial I/O controller. It should be understood that the term “information handling system” is intended to encompass any device having a processor that executes instructions from a memory medium.

Data storage systems or storage devices are devices capable of storing data and/or information. The term storage device (SD) generally refers to mass storage devices, such as hard disk drives (HDD), tape drives, micro-floppy drives, removable cartridge HDD, removable flash memory devices, and optical media drives such as CD-ROM drives and/or DVD drives. The SD may be compliant with well known standards such as the Integrated Drive Electronics/AT Attachment (IDE/ATA) standard and/or may use proprietary standards.

The IHS 100 is shown to include a SD 130 configured as a local hard disk drive. The SD 130 may include a controller (not shown) to control the operation of the device. In an exemplary, non depicted embodiment, the IHS 100 may include additional storage devices.

The processor 110 communicates with the system components via a bus 150, which includes data, address and control lines. In one embodiment, the IHS 100 may include multiple instances of the bus 150. A communications device 145, such as a network interface card and/or a radio device, may be connected to the bus 150 to enable wired and/or wireless information exchange between the IHS 100 and other devices (not shown).

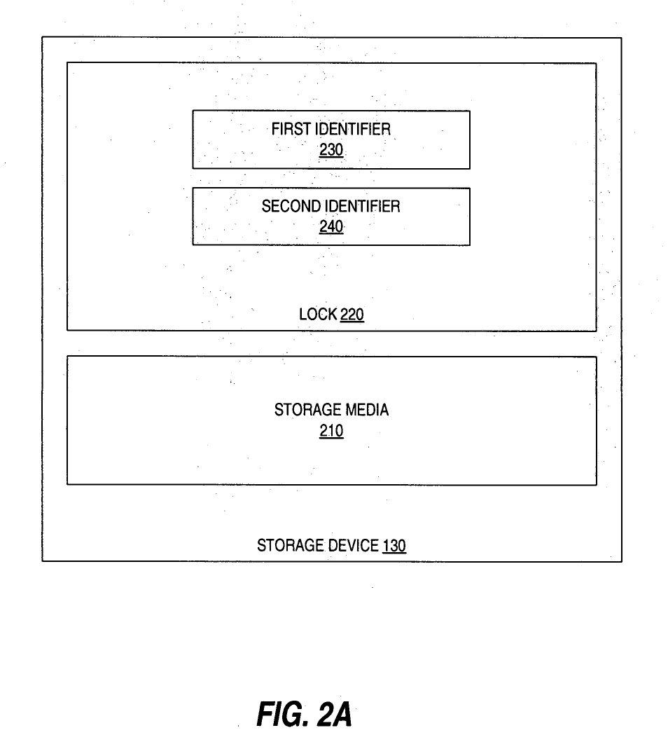

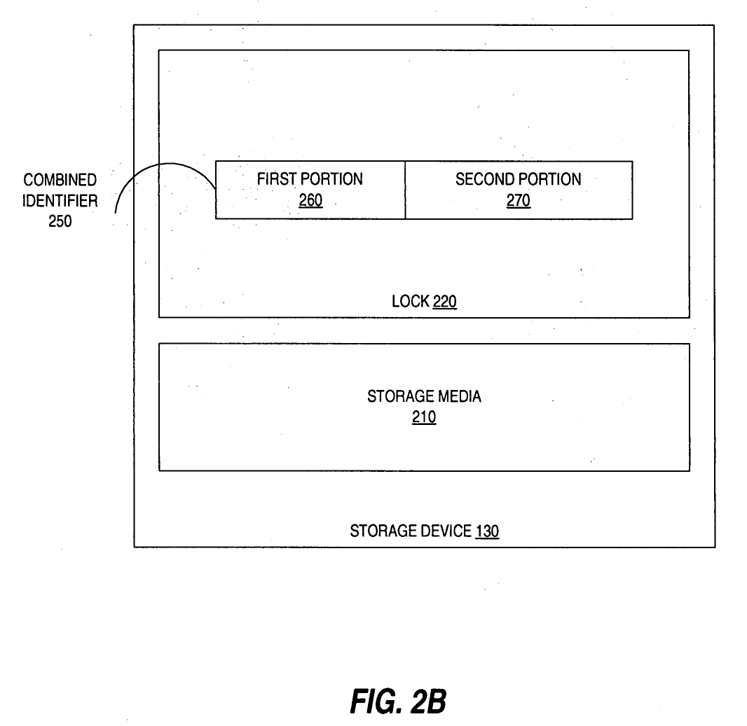

In the depicted embodiment, the SD 130 includes an improved technique that provides secured access to data stored on the SD 130. In a particular embodiment, the SD 130 may be removed or unplugged from the IHS 100 and coupled as a local drive of another IHS (not shown). In an embodiment, the another IHS may be configured substantially similar to the IHS 100. Additional detail of the improved storage device such as the SD 130 is described with reference to FIG. 2A and FIG. 2B.

The processor 110 is operable to execute the computing instructions and/or operations of the IHS 100. The memory medium, e.g., RAM 120, preferably stores instructions (also known as a “software program”) for implementing various embodiments of a method in accordance with the present disclosure. An operating system (OS) of the IHS 100 is a type of software program that controls execution of other software programs, referred to as application software programs. For example, a program 190 stored in the RAM memory 120 and being executed by the processor 110 may request the OS to access data stored on the SD 130. In various embodiments the instructions and/or software programs may be implemented in various ways, including procedure-based techniques, component-based techniques, and/or object-oriented techniques, among others. The BIOS program is typically programmed in an assembler language. Software may also be implemented using C, XML, C++ objects, Java and Microsoft's .NET technology.

FIG. 2A is a block diagram illustrating further details of an improved storage device (SD) described with reference to FIG. 1, according to an embodiment. In the depicted embodiment, the improved SD 130 stores data, which is accessible to components of the IHS 100 including the processor 110.

In the depicted embodiment, the SD 130 includes a storage media 210 to store the data and a lock 220 to control access to the data by the program 190. In a particular embodiment, the lock 220 may be implemented in a controller (not shown) controlling the operation of the SD 130. In a particular embodiment, the storage media 210 may include magnetic and/or optical storage technology. In an exemplary non-depicted embodiment, the program 190 is executable to perform at least one pre-defined function. For example, the program 190 may process interaction with a user (not shown) by processing user inputs/outputs.

In the depicted embodiment, the lock 220 includes a first identifier 230 to authenticate the program 190 and a second identifier 240 to authenticate the IHS 100. In a particular embodiment, authenticating the program 190 includes authenticating the pre-defined function performed by the program 190. In an embodiment, authenticating the program 190 includes authenticating a user seeking access to the SD 130. In an embodiment, the first identifier 230 is a unique identifier to uniquely identify the program 190. Examples of well known unique identifiers include a vehicle identification number (VIN) of an automobile and/or a package tracking number provided by a shipper.

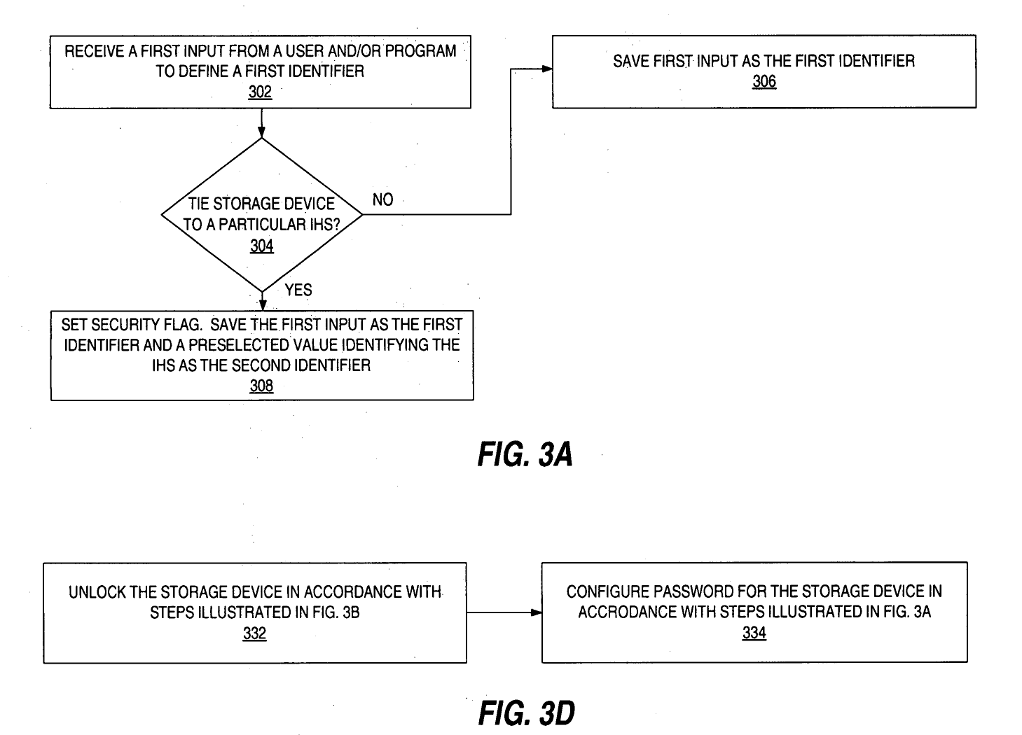

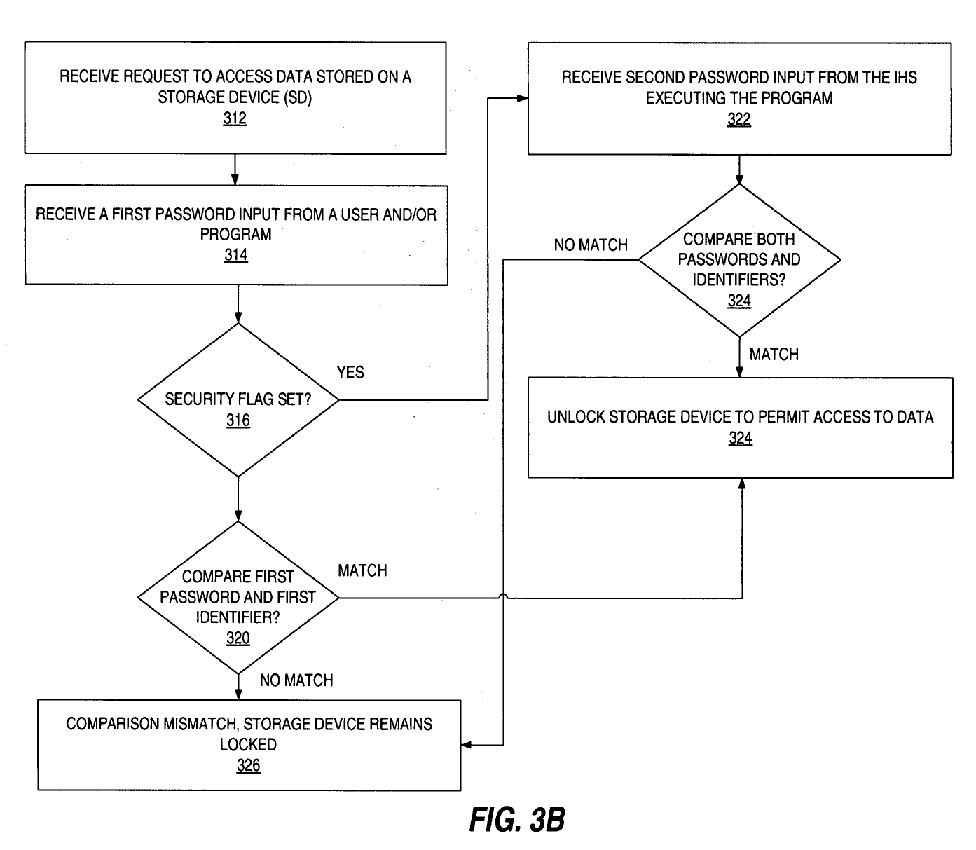

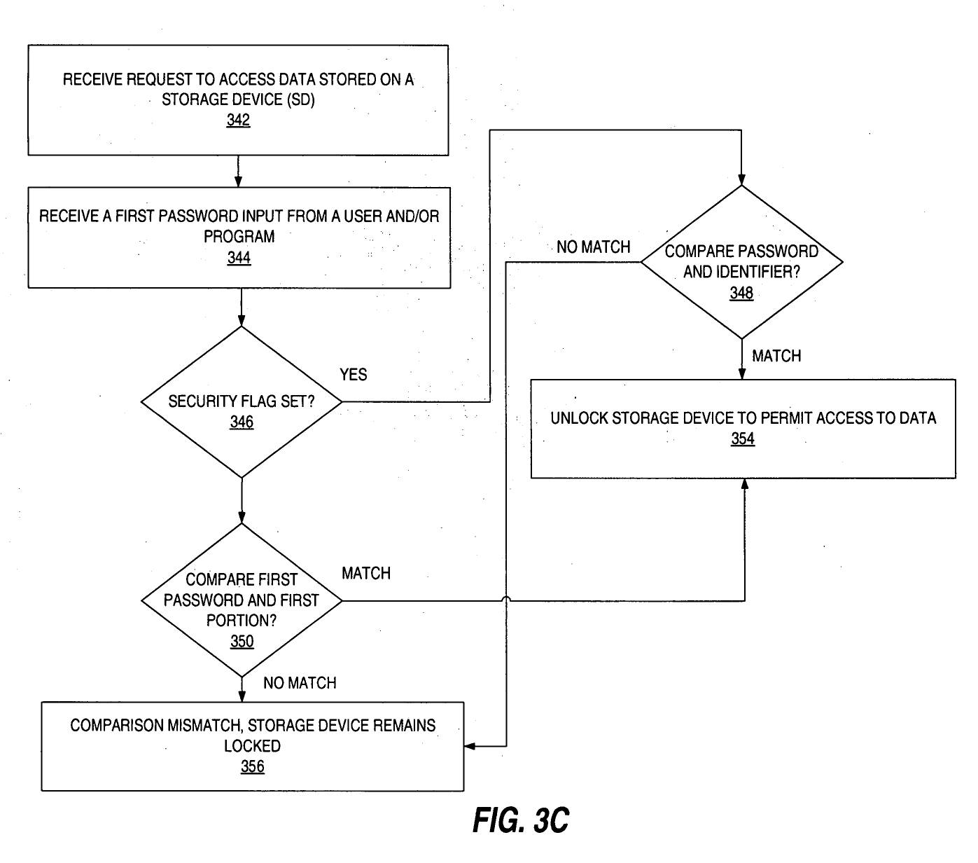

In a particular embodiment, the first identifier 230 uniquely identifies an authenticated user seeking access to the SD 130. In an embodiment, the first identifier 230 may be encrypted/decrypted for enhanced security. The first identifier 230 may include an encryption/decryption key based on a unique identifier number assigned to the SD 130. A value of the first identifier 230 may be initially configured or set up and stored by a BIOS set up program. Additional details of the BIOS set up program are described with reference to FIG. 3A.

Similarly, the second identifier 240 is a unique identifier to uniquely identify the IHS 100. The second identifier 240 may include a unique identification number assigned to the IHS 100, such as a service tag (typically assigned by a manufacturer), an asset tag (typically assigned by a manufacturer and/or a user), a media access control (MAC) address (typically assigned to the communications device 145 coupled to a network) and/or a combination thereof that uniquely identifies the IHS 100. In an exemplary, non-depicted embodiment, another IHS that may be configured substantially similar to the IHS 100 has another second identifier that is different than the second identifier 240 for the IHS 100.

In an embodiment, the second identifier 240 may be encrypted/decrypted for enhanced security. The second identifier 240 may include an encryption/decryption key based on the unique identifier number assigned to the SD 130. A value of the second identifier 240 may be initially configured or set up and stored by the BIOS set up program. In addition, the BIOS set up program may be configured to tie and/or bind the SD 130 to a particular IHS. That is, the SD 130 permits access to the data (e.g., is unlocked) only when the SD 130 is coupled to a particular IHS, such as the IHS 100. In a particular embodiment, the value of the second identifier 240 is pre-selected, e.g., corresponding to the MAC address of the IHS 100 and defined automatically by the BIOS set up program. Additional details of the BIOS set up program are described with reference to FIG. 3A.

During the power on self test phase (POST) of the startup process and before loading of the OS from the SD 130, the BIOS program authenticates or verifies that, when enabled, the SD 130 is coupled to a particular IHS, such as the IHS 100. The authentication is performed to unlock the SD 130 by comparing inputs received from the program 190 and the IHS executing the program 190 with the first identifier 230 and the second identifier 240. Additional details of the authentication process performed during POST to unlock the storage device are described with reference to FIG. 3B.

After initial configuration and set up, a user password and/or the first and second identifiers 230 and 240 may be changed at a later time. For example, a change in the media access control (MAC) address may trigger the change. Additional details of a process to change authentication parameters are described with reference to FIG. 3D.

FIG. 2B is a block diagram illustrating further details of an improved storage device (SD) described with reference to FIG. 1, according to an alternative embodiment. In the depicted embodiment, the lock 220 described with reference to FIG. 2A includes a combined identifier 250. By combining a plurality of identifiers into a single combined identifier, the number of identifiers stored and the number of identifier comparisons made may be advantageously reduced by half. In a particular embodiment, the combined identifier 250 combines the unique identification data and/or information included in the first identifier 230 and the second identifier 240. That is, a first portion 260 of the combined identifier 250 includes unique identification data defined by the first identifier 230. A second portion 270 of the combined identifier 250 includes unique identification data defined by the first identifier 230. In an embodiment, the data and/or information stored in the combined identifier 250 may be encrypted/decrypted for enhanced security. That is, the combined identifier 250 may include an encryption/decryption key based on a unique identifier number assigned to the SD 130.

In the depicted embodiment, a value of the combined identifier 250 may be initially configured or set up and stored by the BIOS set up program. In addition, the BIOS set up program may be configured to tie and/or bind the SD 130 to a particular IHS. That is, the SD 130 permits access to the data (e.g., is unlocked) only when the SD 130 is coupled to a particular IHS, such as the IHS 100. In a particular embodiment, the value of the second portion 270 is pre-selected, e.g., corresponding to the MAC address of the IHS 100 and defined automatically by the BIOS set up program. Additional details of the BIOS set up program are described with reference to FIG. 3D.

After initial configuration and set up, a user password and/or the combined identifier 250 may be changed at a later time. For example, a change in the media access control (MAC) address may trigger the change. Additional details of a process to change authentication parameters are described with reference to FIG. 3D.

FIG. 3A is a flow chart illustrating a method for configuring a lock described with reference to FIG. 2A and FIG. 2B, according to an embodiment. In step 302, a first input is received from a user and/or a program to define or set up the first identifier 230. In a particular embodiment, the first input may include an encryption/decryption key that uses at least a portion of a unique identifier assigned to the SD 130. In step 304, a determination is made whether a storage device is to be tied to a particular IHS. That is, whether access to the data stored on the SD 130 is permitted only when the SD 130 is coupled to the IHS 100. In step 306, in response to determining that the storage device is not to be tied to a particular IHS, the first input is saved in the first identifier 230 and the second identifier 240 is not used. In a particular embodiment, the first input is encrypted and the encrypted value of the first input is saved in the first identifier 230.

In step 308, in response to determining that the storage device is to be tied to a particular IHS, a security flag is set indicating data on the SD 130 is accessible (e.g., is unlocked) only when the SD 130 is coupled to the IHS 100. In addition, the first input is saved in the first identifier 230 and a pre-selected value identifying the IHS providing the first input, e.g., a value corresponding to the MAC address of the IHS 100, is saved in the second identifier 240. In a particular embodiment, the first input and the pre-selected value for the second identifier are both encrypted and the encrypted values are correspondingly saved in the first identifier 230 and the second identifier 240.

In a particular embodiment, the first input is saved in the first portion 260 of the combined identifier 250 and a pre-selected value identifying the IHS providing the first input, e.g., a value corresponding to the MAC address of the IHS 100, is saved in the second portion 270 of the combined identifier 250. In a particular embodiment, the first input and the pre-selected value are both encrypted and the encrypted values are correspondingly saved in the first portion 260 and the second portion 270 of the combined identifier 250.

FIG. 3B is a flow chart illustrating a method for securely accessing a storage device, according to an embodiment. In a particular embodiment, the storage device is the SD 130 described with reference to FIG. 1. Secure access to the data stored on the SD 130 is permitted by an authentication process performed during POST to unlock the SD 130. In step 312, a request is received to access the data stored on the SD 130. The request may be generated by the BIOS program executing the POST instructions. In step 314, a first password input is received from the program 190 and/or a user. The first password input is provided to authenticate the program 190 and/or a user coupled to an IHS system, such as the IHS 100.

In step 316, a determination is made whether the security flag is set in step 308 described with reference to FIG. 3A. In step 322, in response to determining that the security flag is set, a second password input is received from the IHS executing the program 190. In a particular embodiment, the pre-selected value identifying the IHS such as the value corresponding to the MAC address of the IHS is automatically provided as the second password input. In step 324, a determination is made whether a comparison between the first password input and the first identifier 230 and a comparison between the second password input and the second identifier 240 both result in a match. In a particular embodiment, encrypted values for the first password input and the first identifier 230, and for the second password input and the second identifier 240 may be compared to determine the match. In step 320, in response to determining that the security flag is not set, the first password input is compared with the first identifier 230 for authentication. In step 324, the SD 130 is unlocked in response to the match, thereby permitting access to the data. In step 326, a mismatch is detected and the SD 130 remains locked. The mismatch may occur when the SD 130 is coupled to another IHS, since another second password is provided by the another IHS executing the program. The another second password identifying the another IHS does not match the second identifier 240, thereby resulting in the mismatch and disabling the program 190 to access the data. Thus, security of data stored on the SD 130 is enhanced by virtually eliminating access to the data when the SD 130 is decoupled from the particular IHS 100.

FIG. 3C is a flow chart illustrating a method for securely accessing a storage device using a combined identifier, according to an embodiment. In a particular embodiment, the storage device is the SD 130 described with reference to FIG. 1. Secure access to the data stored on the SD 130 is permitted by an authentication process performed during POST to unlock the SD 130. In step 342, a request is received to access the data stored on the SD 130. The request may be generated by the BIOS program executing the POST instructions. In step 344, the first password input is received from the program 190 and/or a user. The first password input is provided to authenticate the program 190 and/or a user coupled to an IHS system, such as the IHS 100.

In step 346, a determination is made whether the security flag is set in step 308 described with reference to FIG. 3A. In step 348, in response to determining that the security flag is set, a determination is made whether a comparison between the first password input and the combined identifier 250 results in a match. In a particular embodiment, encrypted values for the first password input and the combined identifier 250 may be compared to determine the match. In step 350, in response to determining that the security flag is not set, the first password input is compared with the first portion 260 of the combined identifier 250 for authentication. In step 354, the SD 130 is unlocked in response to the match, thereby permitting access to the data. In step 356, a mismatch is detected and the SD 130 remains locked. The mismatch may occur when the SD 130 is coupled to another IHS. Thus, security of data stored on the SD 130 is enhanced by virtually eliminating access to the data when the SD 130 is decoupled from the particular IHS 100.

FIG. 3D is a flow chart illustrating a method for changing authentication parameters, according to an embodiment. In step 332, the SD 130 storage device is unlocked in accordance with the steps described with reference to FIG. 3B or FIG. 3C. In step 334, the password for the SD 130 is configured in accordance with the steps described with reference to FIG. 3A.

With reference to FIGS. 3A, 3B, 3C and 3D, various steps described above may be added, omitted, combined, altered, or performed in different orders. For example, in a particular embodiment, step 330 may be performed before step 332 to enter an administrator password for the IHS before enabling other authentication parameter changes such as user passwords.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware and methods illustrated herein may vary depending on the implementation. For example, it should be understood that while the improved entertainment system is described using a HDD, it would be within the spirit and scope of the invention to encompass an embodiment deploying any storage media devices having a serial number.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present disclosure.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A storage device capable of being coupled to an information handling system (IHS), the device comprising:
a storage media to store data; and
a lock to control access to the data by a program, the program being configured to execute on the IHS, wherein the lock includes a combined identifier having:
a first portion to authenticate the program; and
a second portion to authenticate the IHS.

2. The device of claim 1, wherein the combined identifier is encrypted and decrypted using a predefined cryptographic algorithm and a predefined key.

3. The device of claim 1, wherein the lock permits access to the data when both the program and the IHS are authenticated, wherein the lock denies access to the data when the device is coupled to another IHS.

4. The device of claim 1, wherein the program is authenticated by receiving a first password that is identical to the first portion.

5. The device of claim 4, wherein the first password is provided by the program in response to a user input.

6. The device of claim 1, wherein the combined identifier is encrypted using a key, wherein the key includes at least a portion of a unique number identifying the device.

7. The device of claim 1, wherein the IHS is authenticated when an identifier for the IHS is identical to the second portion.

8. The device of claim 7, wherein the second portion is generated by a basic input/output system (BIOS) program of the IHS to uniquely identify the IHS.

9. The device of claim 1, wherein the device is coupled to another IHS, wherein another identifier is generated by the another IHS to uniquely identify the another IHS, wherein the another IHS is not authenticated due to a mismatch between the another identifier and the second portion.

10. The device of claim 1, wherein the combined identifier is generated by a basic input/output system (BIOS) program of the IHS to uniquely identify the IHS during a set up phase of the device.

11. The device of claim 1, wherein the second portion includes one of a service tag for the IHS, an asset tag for the IHS, and a media access control (MAC) address for the IHS, wherein each one of the service tag, the asset tag and the MAC address uniquely identify the IHS.

12. The device of claim 1, wherein the device is coupled to the IHS as a local drive.

13. A method for accessing data stored on a storage device, the method comprising:
receiving a request from a program to access the data, wherein the device is coupled to an information handling system (IHS);
receiving a first password from the program;
comparing the first password with a combined identifier set up to authenticate the program and the IHS; and
permitting the program to access the data in response to a match between the first password and the combined identifier.

14. The method of claim 13, wherein the combined identifier is encrypted and decrypted using a predefined cryptographic algorithm and a predefined key.

15. The method of claim 13, wherein the device is coupled to another IHS, wherein another identifier is provided by the another IHS executing the program, wherein the another identifier identifying the another IHS does not match the second identifier, thereby disabling the program to access the data.

16. The method of claim 13, wherein a portion of the combined identifier is generated by a basic input/output system (BIOS) program of the IHS to uniquely identify the IHS.

17. The method of claim 13, wherein the combined identifier includes one of a service tag for the IHS, an asset tag for the IHS, and a media access control (MAC) address for the IHS, wherein each one of the service tag, the asset tag and the MAC address uniquely identify the IHS.

18. An information handling system (IHS) comprising:
a processor;
a memory coupled to the processor;
a program stored in the memory; and
a storage device (SD) coupled to the processor, wherein the SD includes:
a storage media to store data; and
a lock to control access to the data by a program, the program being configured to execute on the IHS, wherein the lock includes:
a first identifier to authenticate the program; and
a second identifier to authenticate the IHS.

19. The system of claim 18, wherein the second identifier includes one of a service tag, an asset tag, and a media access control (MAC) address, wherein each one of the service tag, the asset tag and the MAC address uniquely identify the IHS.

20. The system of claim 18, wherein the access to the data by the program is disabled when the SD is coupled to another processor included in another IHS
